(19) United States
(12) Patent Application Publication
(10) Pub. No.: US 2002/0067364 A1
(43) Pub. Date: Jun. 6, 2002

(54) Method for browsing various intelligent design data abstractions

(76) Inventors: John F. Lane, Nashua, NH (US); Pawel Z. Chadzynski, Dunstable, MA (US)

Correspondence Address: DEVINE, MILLIMET & BRANCH, P.A., 111 AMHERST STREET, BOX 719, MANCHESTER, NH, 03105, US

(21) Appl. No.: 09/885,834

(22) Filed: Jun. 20, 2001

Related U.S. Application Data
(60) Provisional application No. 60/213,349, filed on Jun. 22, 2000.

(51) Int. Cl. G09G 5/39

(52) U.S. Cl. 345/531

(57) ABSTRACT

The present invention is a software device for viewing intelligent designs using a computer. The device includes multiple format readers for reading the intelligent designs in at least one of the many possible multiple formats. The device also includes a format verifier that automatically employs an appropriate format reader from the multiple format readers available to read the intelligent designs without explicit user intervention. The device further includes an import application-programming interface for importing the intelligent design in the format required for viewing the intelligent design. Finally, the device includes a memory resident data model, which is a database, for storing the properties and functional characteristics of the intelligent design. The device may further include a query application-programming interface, for presenting data objects to other instances of the apparatus or other application, and a user interface, for interactively accessing the memory resident data model.

### FIELD OF THE INVENTION

The present invention is software. Specifically, the present invention is in the field of computer aided design and electronic design automation software used for the construction of printed circuit boards and similar electronic devices.

### BACKGROUND OF THE INVENTION

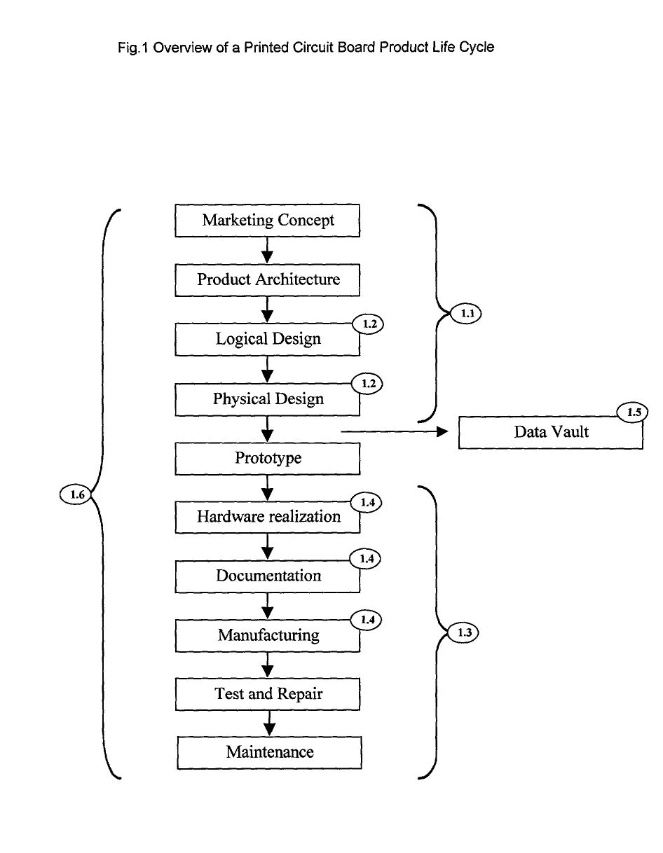

Modern technology companies are completely dependent on the Computer Aided Design/Electronic Design Automation (“CAD/EDA”) tools for designing products. In the design process, CAD/EDA systems are used to capture all of the relevant engineering information from the high level conceptual design all the way to the smallest physical detail such as components, screws and buttons. FIG. 1 shows an overview of a printed circuit board product cycle life.

During the design process various engineering, design, marketing, quality and manufacturing sectors of the organization need a means of access to the evolving design details. This access requirement is accomplished by word of mouth and hard copy written documents. The access requirement is further accomplished through sharing access to a Computer Aided Design/Computer Aided Engineering (“CAD/CAE”) system with the system operators. Sharing the CAD/CAE is required due to limited access licenses and the specialized skills required for accessing a CAD/CAE system.

Some CAD/EDA systems provide specially formatted viewers for their specific data formats that can be used to access the CAD/EDA data. All such viewers are restricted to a single format and do not allow a simultaneous access to different design abstractions (ex: schematic and layout). Therefore, to compare a schematic and a layout of the same printed circuit board design, separate software applications must be opened for the schematic and layout, respectively, tying up excessive memory and requiring the user to be skilled in both applications. An ideal CAD/EDA system would provide simultaneous access to different design abstractions.

Another problem arises when multiple applications are required to access multiple related intelligent designs. Applications often limit or define language used for identifying device elements. Multiple related intelligent designs in differing applications can make it difficult to identify like parts in the same device. Therefore, an ideal CAD/EDA system would a convenient method of identifying like parts of the same design on different intelligent designs.

Once captured, analyzed and resolved within the CAD/CAE system, design data is then communicated throughout the rest of the company by extracting particular sections of the design in the form of partial ASCII files, hard copy plots or reports. These communications are embellished with verbal and written messages. Some output formats can be viewed graphically in format specific viewers. The application software in the CAD/CAE system allows for three-dimensional design construction, although the format specific viewers used to make the design viewable throughout the company is limited to two-dimensional displays, heavily reducing image value. Ideally a CAD/EDA system would have viewers capable of three-dimensional viewing.

The original CAD/CAE data is thereafter moved off the CAD/EDA system to make room for the next design activity and is filed away in the design data storage vaults. Once there, the date of the design work is no longer accessible unless it goes through a process of retrieval and reinstatement on the original CAD/CAE system. This process severely limits access to the totality of the design intent for most individuals in the company. Due to licensing expenses and related constraints, CAD/CAE personnel are normally the only group with full and unrestricted access to the data and then only until the design is filed away in data storage. Other individuals are forced to wait to use the CAD/CAE license, must be assisted by a knowledgeable operator while in front of the CAD/CAE systems, must wait for the plots and/or reports to be generated on the CAD/CAE department's schedule, or simply cannot access the data at all. Once the design data is stored away, the only information that remains readily accessible is partial, inconveniently packaged, and discarded among various parts of the organization. Ideally a CAD/EDA system would enable complete and convenient access to design data, regardless of whether the data is part of an active project or has been archived.

### SUMMARY OF THE INVENTION

The present invention is the result of the realization that by providing a single software application capable of accessing and transmitting a complete electronic product design with three-dimensional imaging and date information, without the need for the host CAD/CAE system, the application establishes a central cockpit for unrestricted browsing, querying and communicating of electronic product design information for the entire company.

Therefore, it is an object of this invention to make CAD/EDA data available without accessing the CAD/CAE system.

It is a further object of this invention to provide simultaneous access to different design abstractions.

It is a further object of this invention to provide connectivity between analogous device elements in different application intelligent designs of the same device.

It is a further object of this invention to provide a viewer capable of three-dimensional viewing.

It is a further object of this invention to provide a viewer capable of retrieving date stamps from data-vaulted intelligent designs.

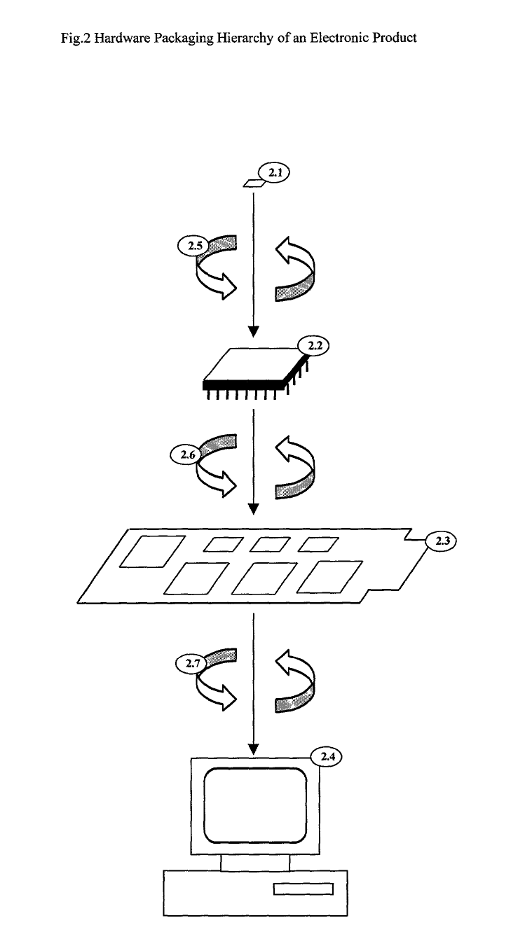

Advantages of the invention can be best understood in the context of electronic product hardware packaging and design phases. All electronic products can be divided into four levels of hardware packaging, as seen in FIG. 2.

IC Die (silicon by itself)

IC Package (die in an enclosure)

PCB (ICs on a board)

System (PCBs in an enclosure)

Each packaging level (2.1-2.4) as well as transitions between the packaging levels (2.5-2.7) present a unique set of data sharing challenges. All of these levels are accessible through the invention as described below.

During design of an integrated circuit (“IC”) die 2.1, the logic expressed in HDL languages (behavioral abstraction) is automatically synthesized into physical blocks of gates and registers (physical abstraction). Once synthesized, the physical elements are then interconnected within the die using various block and gate level routing technologies together with foundry specific technology and manufacturing rules. Functionality of the resulting physical abstraction is then compared to the original HAL description through a combination of test benches and behavioral and functional simulations. Should an undesirable discrepancy be identified between the two, a detailed analysis of the physical layout is needed.

The invention offers a unique and ideal platform for visualization of the physical design during this debugging phase and serves as an ideal source of design data for the analysis tools. It allows the design and the foundry engineers to browse all physical implementation aspects of the design and to correlate the logical abstraction to the physical details regardless of where the design originated.

Die 2.1 design data can be communicated to the invention via the GDSII format, a standard in the die design industry.

Comments and review results can be communicated to the rest of the organization via custom display configurations, annotation in ASCII files, hard copy plots at any zoom factor, and spreadsheet reports.

Packaging 2.5 of the IC die 2.1 within an IC enclosure 2.2 includes assignment of the external I/O pins on the die 2.1 to the corresponding internal I/O pins within the enclosure 2.2. Pins and signal assignments are manipulated in order to minimizes unnecessary electrical delays in the interconnect interface. This requires dynamic and simultaneous pin/signal mapping within the die 2.1 and the enclosure 2.2 while comparing and handling a variety of pin-out and net-list information.

The invention offers a unique and ideal platform for dynamic exchange and visualization of the pin assignments between the die 2.1 and the enclosure 2.2 while eliminating the need for the exchange of data through plots, tables, spreadsheets or written notes. Because the invention is capable of displaying physical aspects of the die 2.1 and the enclosure 2.2, it provides a common communication channel between the two design groups and serves as an ideal source of design data for the related electrical analysis tools.

Die 2.1 design data can be communicated to the invention via the GDSII format, a standard in the die design industry. Enclosure 2.2 design data can be communicated to the invention via various enclosure/board level data formats listed in the Appendix.

Comments and review results can be communicated to the rest of the organization via custom display configurations, annotation in ASCII files, hard copy plots at any zoom factor, and spreadsheet reports.

IC enclosure 2.2 serves as a mechanical package for the die 2.1 plus an interconnect interface between the die 2.1 and the board 2.3. Designers and reviewers require access to the internal mechanical die mounting data as well as the interconnect mapping between the internal and external I/O pins. Pin and signal assignments are manipulated within the enclosure 2.2 in order to minimizes unnecessary electrical delays in the interconnect interface. This requires dynamic and simultaneous pin/signal mapping within the enclosure 2.2 while comparing and handling a variety of pin-out and net-list information.

The invention offers a unique and ideal platform for dynamic exchange and visualization of the pin assignments within the enclosure 2.2 while eliminating the need for the exchange of data through plots, tables, spreadsheets or written notes. Because the invention is capable of displaying physical aspects of the die 2.1 and the enclosure 2.2, it provides a common communication channel between the two design groups and serves as an ideal source of design data for the related electrical analysis tools.

Die 2.1 design data can be communicated to the invention via the GDSII format, a standard in the die design industry. Enclosure 2.2 design data can be communicated to the invention via various enclosure/board level data formats listed in the Appendix.

Comments and review results can be communicated to the rest of the organization via custom display configurations, annotation in ASCII files, hard copy plots at any zoom factor, and spreadsheet reports.

IC enclosure 2.2 serves as an interconnect interface between the die 2.1 and the board 2.3. Designers and reviewers require access to the external mechanical IC enclosure 2.2 data as well as the interconnect mapping between the external enclosure 2.2 I/O pins and the board 2.3 as the enclosure 2.2 is packaged 2.6 within the board 2.3. Pin and signal assignments are manipulated within the enclosure 2.2 and between the enclosure 2.2 and the board 2.3 in order to minimizes unnecessary electrical delays in the interconnect interface. This requires dynamic and simultaneous pin/signal mapping between the enclosure 2.2 and the board 2.3 while comparing and handling a variety of pin-out and net-list information.

The invention offers a unique and ideal platform for dynamic exchange and visualization of the pin assignments between the enclosure 2.2 and the board 2.3 while eliminating the need for the exchange of data through plots, tables, spreadsheets or written notes. Because the invention is capable of displaying physical aspects of the enclosure 2.2 and the board 2.3, it provides a common communication channel between the two design groups and serves as an ideal source of design data for the related electrical analysis tools.

Enclosure 2.2 and board 2.3 design data can be communicated to the invention via various enclosure/board level data formats listed in the Appendix.

Comments and review results can be communicated to the rest of the organization via custom display configurations, annotation in ASCII files, hard copy plots at any zoom factor, and spreadsheet reports.

Board design activity occurs in two major phases: logical (schematic) and physical (layout), 1.2. Although closely related, the activities are often performed by separate groups and the groups are often geographically dispersed. In addition the layout phase is often out-sourced to an outside vendor.

Since the schematic and layout activities are closely related, both groups need a frequent and detailed exchange of design data and the related information. For example, the schematic designers need to indicate and review critical component placement and critical interconnect topologies whereas the layout designers need to annotate schematics with signal termination or part and net assignments.

The invention offers a unique and ideal platform for dynamic exchange and visualization of the schematic and layout design data while eliminating the need for the exchange of data through plots, tables, spreadsheets or written notes. Because the invention is capable of representing all intelligent aspects of a design from all CAD/CAE systems, it provides a common communication channel between the all design groups and serves as an ideal source of design data for the related design performance analysis tools.

Board 2.3 design data can be communicated to the invention via various schematic/layout data formats listed in the Appendix.

Comments and review results can be communicated to the rest of the organization via custom display configurations, annotation in ASCII files, hard copy plots at any zoom factor, and spreadsheet reports.

The overall electronic system 2.4 must be packaged 2.7 into a physical unit that houses and interconnects all of the related electronic modules. While the detailed 3-dimmentional design of the system 2.4 is performed on M-CAD systems, there is a point at which the mechanical and the electrical engineering must somehow relate one to the other.

The invention offers a unique and ideal platform for dynamic exchange and visualization of the electronic layout data against its full 3D mechanical environment. Because the invention has an open application-programming interface (“API”) available to other processes, it allows for dynamic exchange and correlation of design details with external 3D modeling tools. It provides a common communication channel between the mechanical and electrical design groups.

Board 2.2 design data can be communicated to the invention via various layout data formats listed in the Appendix.

Comments and review results can be communicated to the rest of the organization via custom display configurations, annotation in ASCII files, hardcopy plots at any zoom factor, and spreadsheet reports.

### BRIEF DESCRIPTION OF THE INTELLIGENT DESIGNS

The novel features believed characteristic of the invention are set forth in the claims. The invention itself however, as well as other features and advantages thereof, will be best understood by reference to the description which follows, read in conjunction with the accompanying drawings, wherein:

FIG. 1 shows an overview of a printed circuit board product life cycle.

FIG. 2 shows an exploded view of the hardware packaging hierarchy of an electronic product.

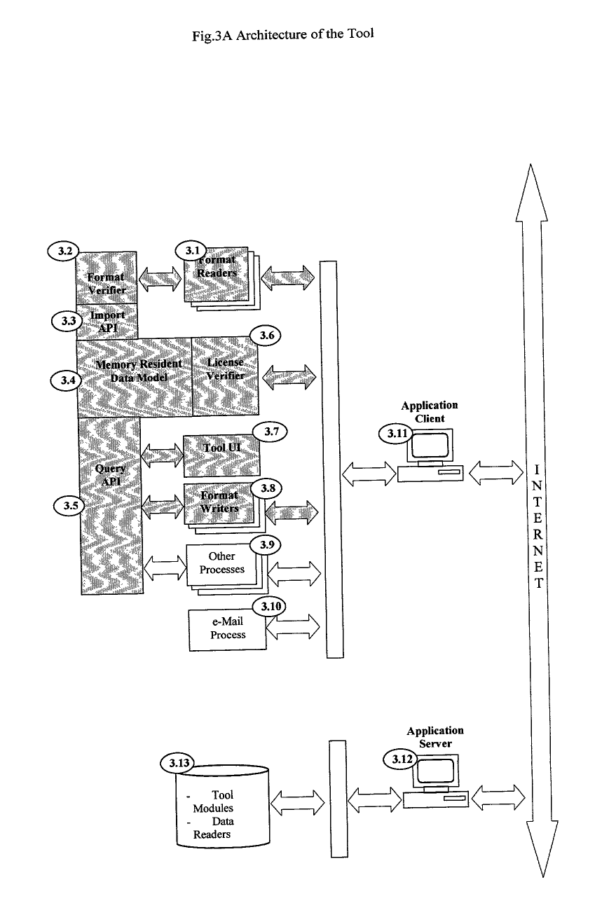

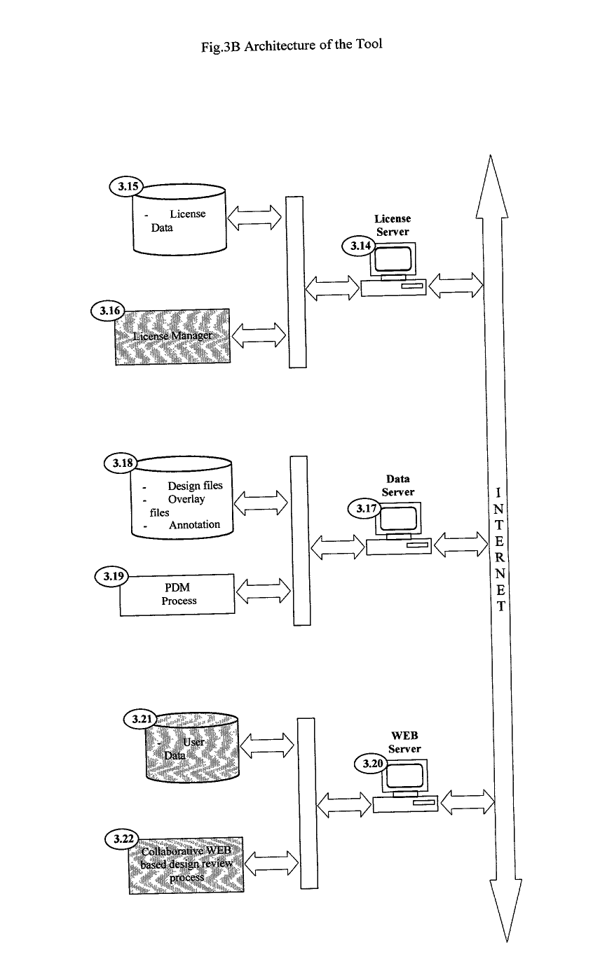

FIG. 3 shows a block diagram of one embodiment of the architecture of the inventive apparatus.

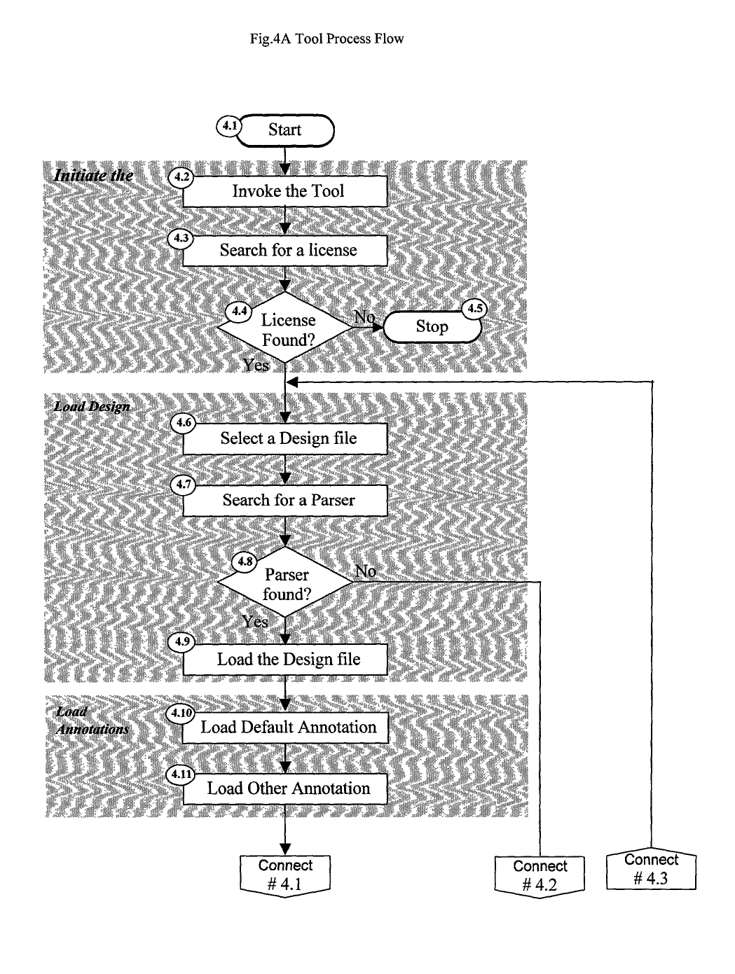

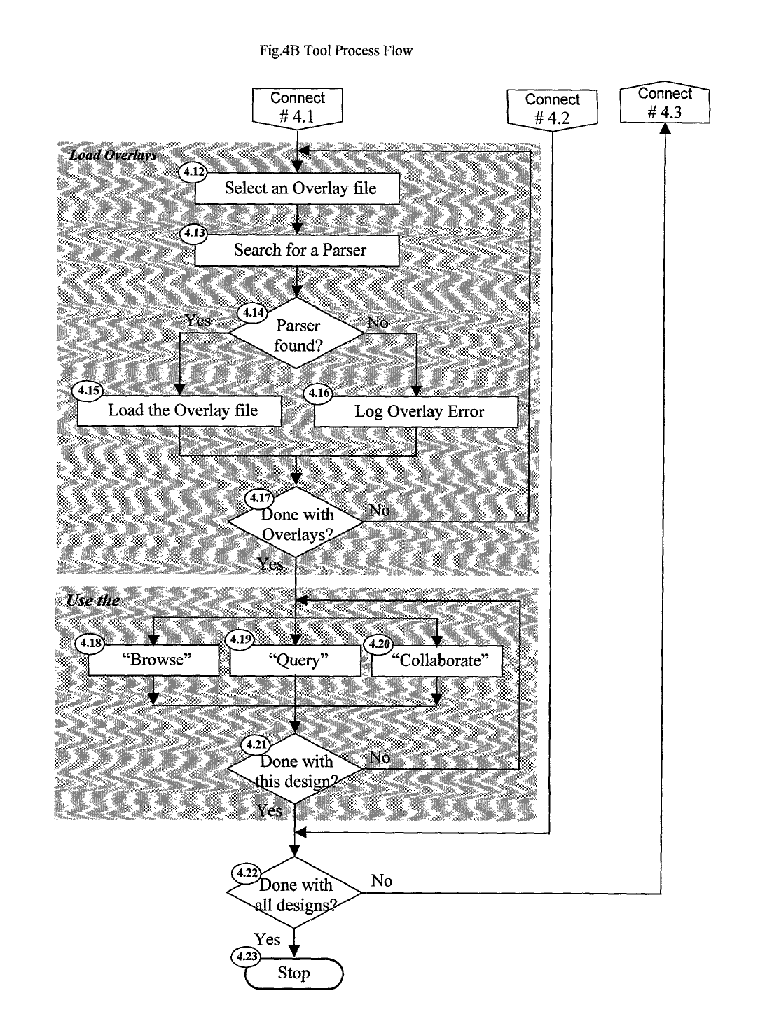

FIG. 4 shows a flow diagram of one embodiment of the inventive method.

### DETAILED DESCRIPTION OF THE INVENTION

The invention is a software system that executes under any of the commercial operating systems (“OS”) on the market: Windows, Unix, Linux and Apple and prospectively other operating systems developed in the future. It consists of the following core building blocks that are critical to the specific usefulness and characteristic of the invention:

Multi Platform Execution (FIGS. 3A and 3B):

client/server implementation with like functionality across different OSs

same binary image for all Windows OSs (95, 98, NT, 2000 and Millennium)

separate binary image for Unix versions, Linux versions and Apple OSs

Client/server means that the invention modules interact among two or more networked computers as documented in FIGS. 3A and 3B. This feature includes the case where all modules reside on a single computer without the need for the network. Phantomed process modules and data/control paths indicate elements that do not constitute primary building blocks of the invention. These blocks, inventive and otherwise, can be packaged in various configurations to obtain appropriate combinations of capabilities.

Proprietary and Memory Resident Run-Time Database 3.4:

client/server implementation

CAD/EDA objects required to represent an intelligent PCB layout design

CAD/EDA objects required to represent an intelligent schematic design

CAD/EDA objects required to represent a 2.5D mechanical design

CAD/EDA objects required to represent a functional block diagram

The run-time database 3.4 constitutes the heart of the invention. It is a fundamental building block that always must be present in all configurations of the invention. This database keeps all of the CAD/EDA data constructs, properties and functional characteristics. In a client/server environment this database 3.4 is a server that may but does not have to reside on the networked node from which the process is launched and used.

Integration with the Basic Internet Environment:

support of URL links for loading design data directly from the Internet 3.21 and from packet data module (“PDM”) processes 3.19.

support of URL links for dynamic reference between objects in the invention and data on the Internet 3.20.

support of MAPI links for direct exchange of design data between the invention and the local e-mail application 3.10.

Integration with Internet means the invention is able to communicate through basic high-level Internet mechanisms such as the IMAP application protocols and the URL data links. IMAP enables exchange of data with the local e-mail package 3.10. URL allows reaching data files (read/write) and data objects anywhere on the Internet.

Graphical User Interface 3.7:

client implementation with like functionality across different OS's

Point-and-click implementation of drop down menus, tool bars with icons, and dialog boxes

loading of design data (CAD/CAE designs and annotations)

exporting and importing of design data

display manipulation (visibility, zoom, color, highlight, units, etc.)

navigation of the design structures (hierarchy, connectivity)

search (finding objects by their characteristics)

measure (distances within or between graphical representations of physical objects)

query of design objects (examining non-graphic characteristics of objects)

interactive entry of annotations, including bookmarks

The run-time UI 3.7 constitutes the primary means of interactive access to the invention. The run-time UI 3.7 graphically presents the data on the local computer and provides access to all interactive invention commands. It is a fundamental building block but it may not be present in all configurations of the invention. If not present, then the invention is a run-time database accessible through API. In client/server environment this run-time UI 3.7 is a client that must reside on the networked node from which the invention is launched and used.

Scripting Language 3.8:

ASCII scripting language that can be created and manipulated with the basic text editors

script API within the invention 3.5

definition of the initial state of the invention on start (command defaults, visibility defaults, data load defaults)

definition of the user-defined run-time states of the invention during execution, referred to as bookmarks (command defaults, visibility defaults, data load defaults)

Scripting language allows the user to control local configuration and behavior of the run-time UI 3.7. This control can be applied during software launch (a start-up control) or during execution, bookmark. During the execution, scripts can be loaded or generated. Generating a script while using the invention helps to capture a particular state of the configuration and then to communicate it to other users or to recall it later on during the process.

Library of Database Reading Modules 3.1:

Automatic matching of data with a reading module 3.2

Open API for creating custom format readers 3.3

Reading modules import data from a specific external file into the Client's run-time memory resident Data Model 3.4. They are implemented as modules that are separate from the memory resident Data Model 3.4. The reading modules 3.1-3.3 are used to load external data into the invention's run-time Data Model 3.4. These modules communicate with the invention through open API that is independent of the OS platform. Matching of a module to a format is automatic and does not require user intervention.

Library of data export modules from the run-time database to the specific external files implemented as separate modules from the basic memory resident Data Model 3.4

Export modules are used to extract data from the memory resident Data Model 3.4. These modules communicate with the Data Model 3.4 through on open API that is particular to the OS platform. (is this ‘export module’ the same as the scripting language?)

Licensing Mechanism (FIG. 3, Item 3.6 and 3.14-16):

Client/Server licensing model

Floating and Node Locked licensing modes

Time limited conversion of licenses from Floating to Node Locked

Date based expiration

Control for simultaneous number of users

Licensing controls the right to use an installed copy of the Tool based on node location, time and number of users. Licensing Server may reside anywhere on the network including the local node from which the Tool is launched. A unique aspect of this Tool's licensing is the ability to take a Floating license and convert it to a time-limited Node Locked license. This enables a networked user to continue working without being on a net. This is accomplished via interaction of the invention with the Web based licensing process (FIG. 3, item 3.20).

Design Collaboration 3.9

a protected WEB portal designed for interactive sharing of design data

a chat room-like environment with graphical and textual data exchange

interactive pushing of the invention's state (bookmarks) from the invention to the WEB portal

interactive pulling of the invention's state (bookmarks) from the WEB portal to the invention

The WEB portal is a software service on the Internet with a tight integration of data exchange between the invention and the WEB portal. Using the invention 's Internet communication protocol users can link into a community of interactive participants for the purpose of reviewing, commenting on and sharing information regarding designs resident in the invention's run time database. By pushing/pulling graphical the invention's graphical data to/from the portal, all participants can be actively engaged in a design discussion even if they are geographically dispersed.

The invention also includes an inventive process. The process, as shown in FIG. 4, includes the following steps:

4.1 Start the System on Which the Inventive Software (the “Tool”) will be Run.

4.2 Invoke the Tool.

The Tool can be invoked in a variety of ways:

Click on the Tool icon

Click on a data file registered against the Tool

Drag/Drop of a file icon over the Tool icon

System directive from an independent process such as PDM.

The Tool itself may reside on the Client or on a Server. When the Tool resides on a Client, then it is invoked as any other software that resides on this Client. When it resides on a Server then the Tool is invoked by loading itself into the local memory followed by registering on the Client all reading and writing modules found on the Server.

4.3 Search for a License

After initiating on the Client but before allowing selection of a data file the Tool goes through a license verification process 3.6. The license can be retrieved from a Client or from a Server 3.14-3.16, depending on the configuration.

In case the license is not found automatically, the Tool initiates an interactive sequence by requesting the user to explicitly identify location of a license anywhere on the network.

A license may also be obtained for operating the Tool off of the Internet. A license for operating using the Internet is called a Floating license. Once a Floating license is granted, the user has an option to convert it into what is termed a temporary Node Locked license. This license allows the user to continue the work off the Internet. This process is referred to as Consignment Licensing and it requires active access to the appropriate Web services 3.22. This action can be performed at any time after successful initiation of the Tool.

4.4-5 License Found? Decision

The Tool will not initiate unless a valid license is located. However, the user is presented with an opportunity to request a license from Web services 3.22 before the Tool exits.

4.6 Select a Design file

A design file may be selected in a variety of ways:

Click on a data file registered against the software before the Tool initiates.

Drag/Drop of a file icon over the Tool icon before the Tool initiates.

System directive from an independent process such as PDM.

Open Design command from a File menu after the Tool initiates.

Defined as a URL link in a Bookmark script.

4.7 Search for a Parser (FIG. 4, Item 4.7)

At first the Tool attempts to match the file extension to a format reader 3.1 associated with it. If the extension is not recognized, then the file is presented to the first available reader 3.1.

The reader 3.1 opens the file and the format verifier 3.2 verifies the beginning of the file does correspond to the proper format. If it corresponds, the reader 3.1 informs the Data Model 3.4 of a success and proceeds to read the rest of the file. If it does not correspond, then the reader 3.1 informs the Data Model 3.4 of a failure and exits.

If the Data Model 3.4 is informed of a failure then it presents the file to the next available reader 3.1 until the format is recognized or until there are no more readers 3.1 available. If the Data Model 3.4 is informed of a success then it waits until the Reader 3.1 is finished loading the data.

This step of the process relieves the user from having to know anything about the source or the format of the file.

4.8 Parser Found? Decision

If the last Reader available fails to recognize the data format then the Tool proceeds to step 4.22.

4.9 Load the Design File

The import API 3.3 converts Data Model of the file format to the Data Model 3.4 of the Tool and creates a run-time database.

4.10 Load the Default Annotation Files

After finishing loading of a design file, the Tool initiates loading of the default Annotation files through the format writers 3.8. These files contain scripts that define the initial state of the Tool. They also contain scripts that define Bookmarks, which are various other states of the Tool that can be invoked by name anytime after the data loading is finished.

The default Annotation files are located by their names and paths according to a fixed search scenario file pathname. This allows automatic loading of specific Tool configurations with respect to the design.

4.11 Load the Other Annotation Files

The user, through the appropriate Annotation file load procedure other processes 3.9, may also load annotation files at any time after design load is completed. User loaded Annotation files may also contain Redline in addition to the Bookmark scripts. Redlines represent design markups created by other users.

This step is repeated at various times in order to facilitate asynchronous collaboration with other Tool users. Each user can read data whenever appropriate and without requiring the other user to be on-line.

4.12-17 Load the Overlay Files

After finishing loading of a design file, the user may load any number of Overlays. Overlays allow visual matching of various physical definitions of a design (ex: component placement contained in a design file vs. pad definitions contained in an associated Gerber film.)

Overlay data is typically expressed in many different formats. A similar loading/parsing technique is used as in the case of design data thereby relieving the user from having to know what format is used in the first place. The only difference from design load is that the Tool issues an appropriate message without terminating the run in case a parser is not found.

4.18-19 Browse, Query

The user starts Browsing 4.18 and Querying 4.19 design data according to her needs at any time after loading design data. This is done via the various functions and options of the run-time UI 3.7 and continues at the user's discretion.

4.19 Query—Cross Highlight

The user invokes Cross-Highlighting operations between any two sessions of the Tool at any time after loading design data. This can also be accomplished between the Tool and some other process. Cross Highlighting allows one Tool to communicate an object of interest (Pin, a Component and/or Net) to the other Tool for visual highlighting.

In case of a Net, the Tool employs a unique algorithm where the corresponding Nets are identified by their connectivity (pins) instead of their specific Net names. This is critical since many schematic and printed circuit board (“PCB”) systems create data with altered signal names between the two abstractions. It also allows for efficient Cross Highlighting of bus structures.

4.20 Collaborate—Markups

The user invokes the process of creating markups at any time after loading design data. This is accomplished with drafting and text-editing functions, which place data on dedicated Overlay within the memory resident Data Model 3.4. Markups are used to clearly indicate areas of particular interest within the graphical context of a design.

Once entered, markup text can be automatically located via the Search mechanism. Search markup text is listed in a way that allows the user to pan/zoom to its exact location by clicking on the appropriate entry in the listing.

Collaborate—Bookmarks

The user invokes the process of defining Bookmarks at any time after loading design data. Bookmarks are named scripts which capture a specific state of the Tool including:

States of all commands

Snap shot of zoom, pan, visibility and colors

Snap shot of all highlighted objects (Pins, Components and Nets)

Snap shot of all existing mark-ups

Each Bookmark has a unique user defined name, which allows recalling them at any time with a click of a mouse.

Collaborate—Communicate

The user invokes the process of communicating Bookmarks at Markups at any time after defining them. Such user-defined data can be sent instantly via an automatic attachment to e-mail 3.10 or by storing an external Annotations file that will be shared with others at a later time. Annotation files can also be used to recall previous states of the Tool (analogous to backup/restore or undo operations).

These Annotation files are preferably written in an XML syntax enabling other processes to use them as well. They also contain URL links to the design data itself thereby avoiding multiple replication of the original design file. These URL links also provide a protection against unwarranted disclosure of the design data, which always resides in its original location (ex: behind the company's intranet fire wall).

This step is repeated at various times in order to facilitate asynchronous collaboration with other Tool users. Each user can read data whenever appropriate and without requiring the other user to be on-line.

This step is repeated at various times in order to facilitate asynchronous collaboration with other Tool users. Each user can read data whenever appropriate and without requiring the other user to be on-line.

Accordingly, what is claimed is:

1. An apparatus for viewing at least one intelligent design using at least one computer, said apparatus comprising:
a library of format readers for reading at least one intelligent design saved in a specific format;
a format verifier linked to the format readers for matching the intelligent design to one of the format readers capable of reading the specific format;
an import application-programming interface linked to the format verifier for importing the intelligent design in the applicable format for viewing the intelligent design; and
a memory resident data model, linked to the import application-programming interface, is a database for storing the properties and functional characteristics of the intelligent design.

2. The apparatus for viewing at least one intelligent design in claim 1 further comprising:
a query application-programming interface, linked to the memory resident data model, for searching for at least one element in the memory resident data model; and
a user interface, linked to the query application-programming interface, for interactively accessing the memory resident data model.

3. The apparatus for viewing at least one intelligent design in claim 2 further comprising at least one format writer, linked to the query application-programming interface, for scripting within the invention thereby allowing the user to control local configuration and behavior of the user interface.

4. The apparatus for viewing at least one intelligent design in claim 1 further comprising a collaborative network element, linked by at least one medium to the memory resident data model, for using the apparatus across a global computer network.

5. A method for viewing at least one intelligent design using at least one computer and a software application, said method comprising: initiating the software application;
selecting a design file;
searching for a parser which is used to identify a means for opening the design file;
loading the design file using the parser; and
browsing the design file.

6. The method for viewing at least one intelligent design of claim 5 further comprising:
loading at least one default annotation file; and
loading at least one scripted annotation file.

7. The method for viewing at least one intelligent design of claim 5 further comprising:
selecting an overlay file;
searching for a parser for the overlay file; and
loading the overlay file.
